(19) United States
(12) Patent Application Publication
(10) Pub. No.: US 2023/0419216 A1
(43) Pub. Date: Dec. 28, 2023

(54) CLOSED LOOP VERIFICATION FOR EVENT GROUPING MECHANISMS

(71) Applicant: International Business Machines Corporation, Armonk, NY (US)

(72) Inventors: Pooja Aggarwal, Bengaluru (IN); Harshit Kumar, Delhi (IN); Amitkumar Manoharrao Paradkar, Mohegan Lake, NY (US); Rama Kalyani T. Akkiraju, Cupertino, CA (US)

(21) Appl. No.: 17/809,077

(22) Filed: Jun. 27, 2022

(51) Int. Cl. G06Q 10/06

(52) U.S. Cl. CPC G06Q 10/06316

(57) ABSTRACT

A method and system is provided for utilizing a causal dependence graph of events in a large enterprise-related system to determine a most frequently utilized corrective action for a set of actions that the enterprise requires. Typically, with large sets of data related to actions that an enterprise system performs, it is non-trivial to correlate a set of actions (or workflows) with a set of corrective actions.

### BACKGROUND

The present invention generally relates to the field of event grouping, and more specifically to utilizing non-trivial methods to improve event grouping mechanisms for enterprise-related events.

### SUMMARY

According to an aspect of the present invention, there is a method, computer program product and/or system that performs the following operations (not necessarily in the following order): (i) receiving a first system state, with the first system state including a plurality of events, and with the plurality of events being included in a first grouping; (ii) determining that the first grouping is non-satisfactory for the first system state; (iii) responsive to the determination, taking a corrective action, by a system engineer, with the corrective action including performing a set of action(s) to a first sub-set of events included in the first grouping; (iv) correlating the set of action(s) to the first sub-set of events with the first sub-set of events to create a causal dependence graph of events; and (v) utilizing the causal dependence graph of events to determine a corrective action of the set of action(s) to determine the most frequently utilized corrective action.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a flow diagram showing a system architecture of a first embodiment system according to the present invention;

FIG. 5 is a flow diagram showing information that is helpful in understanding embodiments of the present invention;

FIG. 6 is a flow diagram showing information that is helpful in understanding embodiments of the present invention; and

FIG. 7 is an event grouping diagram showing information that is helpful in understanding embodiments of the present invention.

### DETAILED DESCRIPTION

Some embodiments of the present invention are directed towards utilizing a causal dependence graph of events in a large enterprise-related system to determine a most frequently utilized corrective action for a set of actions that the enterprise requires. Typically, with large sets of data related to actions that an enterprise system performs, it is non-trivial to correlate a set of actions (or workflows) with a set of corrective actions.

This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

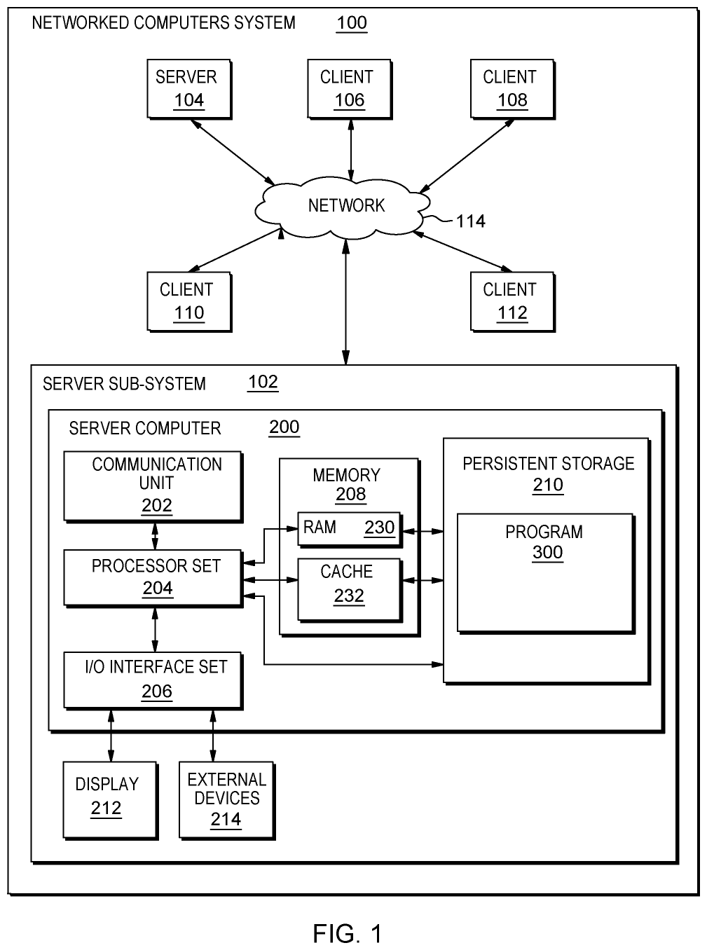

An embodiment of a possible hardware and software environment for software and/or methods according to the present invention will now be described in detail with reference to the Figures. FIG. 1 is a functional block diagram illustrating various portions of networked computers system 100, including: server sub-system 102; client sub-systems 104, 106, 108, 110, 112; communication network 114; server computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

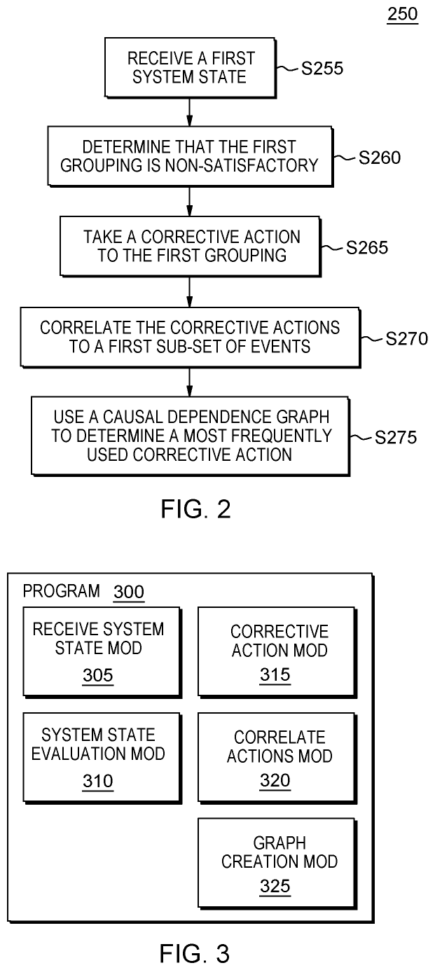

FIG. 2 shows flowchart 250 depicting a method according to the present invention. FIG. 3 shows program 300 for performing at least some of the method operations of flowchart 250. This method and associated software will now be discussed, over the course of the following paragraphs, with extensive reference to FIG. 2 (for the method operation blocks) and FIG. 3 (for the software blocks).

Processing begins at operation S255, where receive system state module (“mod”) 305 receives a first system state. In some embodiments of the present invention, the first system state provides an indication of the overall health of a given computing system at a particular point in time. The system state includes information that shows the processes that are undertaken in a given computing system by looking at a large set of computing events. Typically, these computing events are included in a first grouping (sometimes herein referred to as an “event grouping”).

Processing proceeds to operation S260, where system state evaluation mod 310 determines that the first grouping of computing events (discussed in connection with operation S255, above) is non-satisfactory. As mentioned above in connection with operation S255, the system state indicates an overall health of the computing system. In order for system state evaluation mod 310 to determine that the first grouping of computing events is non-satisfactory, mod 310 must determine that at least some of the events in the event grouping are deficient (that is, at least some events in the event groupings contain a “fault”). A fault typically means that a process that is run as part of an event has failed. This can occur when an event(s) has exceeded a threshold for memory utilization.

Processing proceeds to operation S265, where corrective action mod 315 takes a corrective action (or multiple corrective actions) for each event included in the first grouping. In some embodiments of the present invention, corrective action mod 315 first determines what the “fault” in the event(s) is. After determining the fault in the event(s), corrective action mod 315 suggests to a systems engineer a host of solutions that can potentially alleviate the fault, which the systems engineer can then implement. Alternatively, a systems engineer can independently determine which corrective action to take based upon observing a set of “golden signals” that an event(s) provides. The use of “golden signals” to remedy faults is discussed in greater detail in Sub-Section III, below.

Processing proceeds to operation S270, where correlate actions mod 320 correlates the corrective actions taken to the set of computing events that have “faults” (discussed in connection with operation S265, above) with a first sub-set of computing events included in the first grouping. In the context of enterprise solutions, correlating a corrective action to a set of problematic (or potentially problematic) events is a non-trivial task. In some embodiments, correlate actions mod 320 individually determines a one-to-one correlation of problematic events to the corrective actions taken. Alternatively, correlate actions mod 320 determines a correlation based upon the frequency of any given problematic event occurring in the first system state with a frequently utilized corrective action that is used to remedy a pre-defined portion of the problematic events.

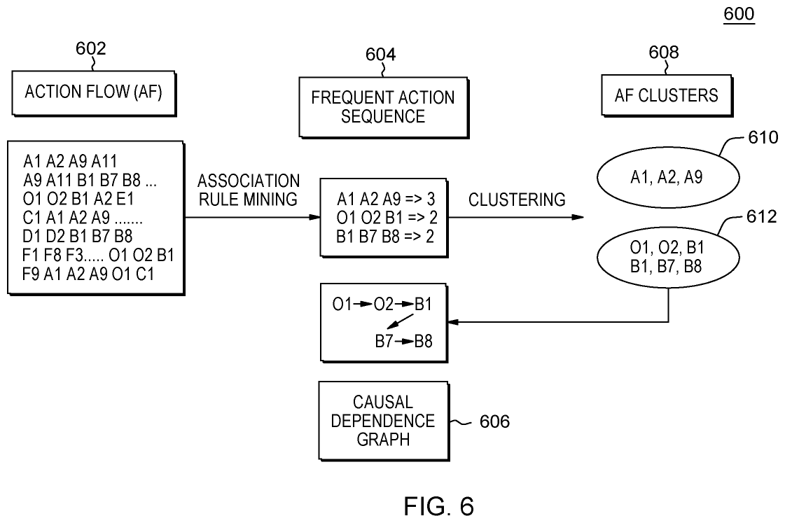

Processing finally proceeds to operation S275, where graph creation mod 325 creates a causal dependence graph based on the correlations made between the corrective actions taken to the set of computing events and the first sub-set of computing events included in the first grouping (discussed in connection with operation S270, above). In some embodiments of the present invention, the causal dependence graph is used to determine which corrective action (if any) was used most frequently on the first sub-set of computing events. In some embodiments, graph creation mod 325 uses an action list (AL) and a dictionary of action flows (such as action flows 602 shown in FIG. 6).

### III. Further Comments and/or Embodiments

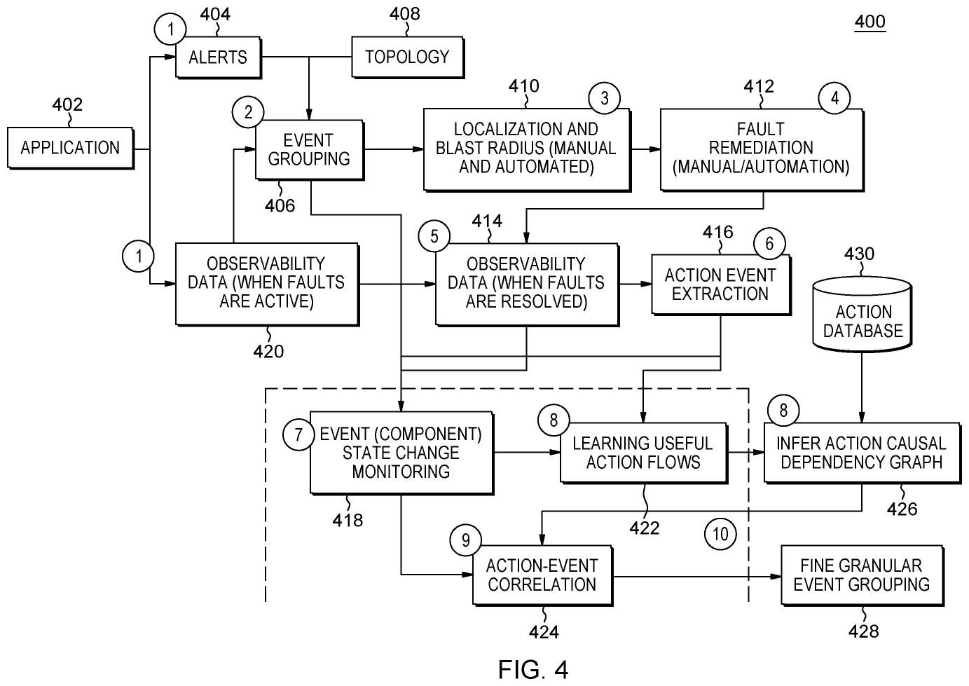

In some embodiments, a computing event includes any IT operation. In some embodiments, a group of computing events (such as event grouping 406 shown in FIG. 4) are created in order to efficiently process a set of tasks for an enterprise system; however, it is not necessarily the case that every grouping of events that is identified and/or created will yield a favorable result. In some embodiments, it is necessary to observe how these groups of computing events (herein referred to simply as “events” or “event groups”) alter the state of a computing system(s) in order to determine whether the event grouping is done correctly. It is important to note that the determination of whether the event groupings are done correctly based upon how the computing system(s) is altered is a non-trivial determination.

The benefits of utilizing embodiments of the present invention include: (i) observability data is precise; (ii) entity related information that are contained in logs are precise; (iii) in enterprise-related applications, there is a tendency for multiple faults to occur at the same time, and due to the temporal nature of these faults, these faults are sometimes incorrectly grouped together; (iv) logs, metrics, and/or traces footprints contain non-obvious clues about the actions taken to resolve an issue that corresponds to a particular event; and (v) the ability to leverage observability data (such as observability data 414 and 420) to correlate actions and events is useful in determining related events, thereby building action driven fine granular event groups.

Some embodiments of the present invention learn action flows and their resolutions from logs using initial output of event grouping service and analyzing the logs from the period starting from when fault is first triggered to the time it got resolved. This process will help in learning action flows in order to resolve each event.

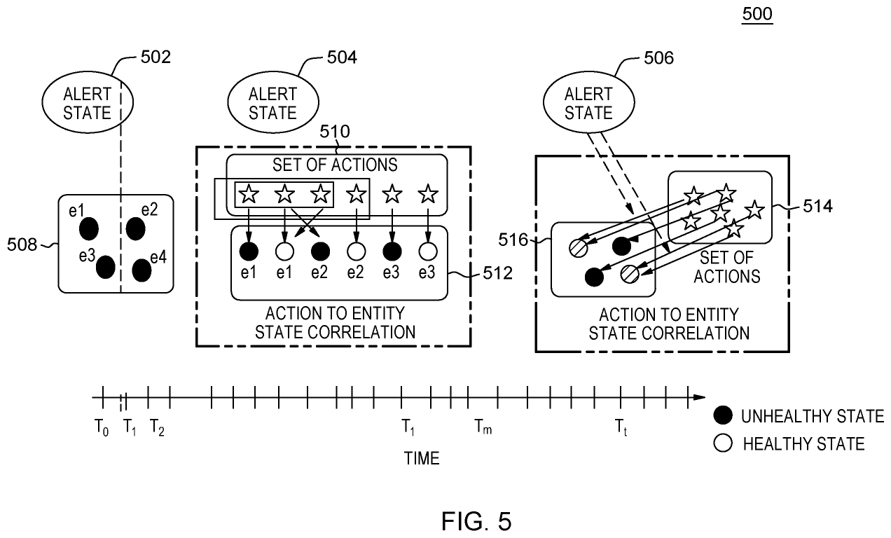

Some embodiments of the present invention build an action causal dependency graph (such as infer action causal dependency graph 426 referenced in FIG. 4) by inferring causal relationships between frequently occurring action flows. This process provides the following advantages: (i) helps in noise reduction in action flows (that is, actions that are not necessarily required); (ii) observes the change of state of the computing system to identify if it resulted in resolving the issue in a given event; and (iii) associates the action with the state change and action verification leading to a state change from an unhealthy state to a healthy state (as shown in aspects of FIG. 5).

Some embodiments of the present invention provide a feedback mechanism that results in fine granular grouping of events based on actions that are taken to resolve certain events.

Some embodiments of the present invention provide a mechanism for learning action flows. This inputs for this mechanism include historical event groups and observability data. In some embodiments, historical event groups includes information that indicates a group of events, services and/or components that are impacted, and associated entities (such as pods and deployments). In some embodiments, observability data includes log data and metrics data.

Using these inputs, the mechanism operates as follows:

For each group (G) that is being analyzed, the following actions are taken:
(1) During the period of time in which the group (G) was active, embodiments of the present invention use a pre-trained classifier to classify each log line into one of the classes (such as “action,” “error,” and/or “healthy”);
(2) If the label type is “action,” then embodiments of the present invention identify they type of action from the action classes. In some embodiments, the possible action types are: restart pod, increase memory, decrease memory, scale up services, scale down services, de-duplicate pods, create additional instances, etc.; and
(3) For each event (e) that is a part of the group (G), some embodiments extract tuples for event (e) using observability data. One example of this extraction includes the following: {“entity_1”:{“action_type”:“restart_pod”, “ts”:2382929}, “entity_2”:{“action_type”:“increase memory”, “ts”:7939292}}], where entity_1, entity_2 are entity names.

Additionally, some embodiments check logs to see whether there are any “golden signals” in order to detect a system status. As used throughout this document, the term “golden signals” includes, but is not necessarily limited to, graphs showing: computer latency, CPU saturation percentages, communications signal strength, memory utilization, etc.

Some embodiments check the state of the computing system with a timestamp plus a certain delta, with the delta being a function of the action type (referenced above). Some embodiments update a dictionary with the system state outcomes as a success or failure. One example of this update includes: {event_1={“entity_1”:{“action_type”:“restart_pod”, “ts”:2382929, “delta_ts”: 2382929 , system_state:“unhealthy”}, “entity_2”:{“action type”:“increase memory”, “ts”:7939292}, “delta_ts”: 7939352 , system_state:“healthy”}. Finally, some embodiments add this dictionary to an action list (AL).

The outputs for this mechanism includes the action list (AL) (that is, the list of all of the corrections that need to be made). For each event that is analyzed, embodiments of the present invention receive a sequence of actions, with each action being performed on an entity at time (t) and the resulting system state at a later time (t+t′).

Flow diagram 400 of FIG. 4 shows a general system architecture for implementing embodiments of the present invention.

Flow diagram 400 includes: application 402, alerts 404, event grouping 406, topology 408, localization radius 410, fault remediation module 412, observability data 414, action event extraction 416, event/component state change monitoring module 418, observability data 420, learning useful action flows module 422, action-event correlation module 424, infer action causal dependency graph 426, fine granular event grouping module 428, and action database 430.

In some embodiments, the events that make up event grouping 406 includes computing events such as alerts, log anomalies, metrics-based alerts, and/or other metrics-related anomalies that are received from a set of disparate sources (such as a set of virtualized distributed computing servers).

In some embodiments, observability data 414 includes visual data (such as graphs) that show information relating to the performance of a given computing system when faults are resolved (through the operations of fault remediation module 412). In some embodiments, observability data 420 includes visual data (such as graphs) that show information relating to the performance of a given computing system when these faults are active. In both instances of the observability data, this data includes memory workload, CPU workload, etc.

After receiving the observability data (both observability data 414 and 420), embodiments of the present invention start to identify certain actions (such as actions taken by a user, including a systems engineer) with a set of computing events. This is done in order to provide helpful input data for learning useful action flows module 422. With this data, learning useful action flows module 422 helps to build a causality dependence graph (such as infer action causal dependency graph 426).

Flow diagram 500 of FIG. 5 shows a timeline of events that occur in order to ultimately correlate a set of actions with a set of entities.

Flow diagram 500 includes: alert state 502, alert state 504, alert state 506, set of entities (unhealthy state) 508, set of actions 510, action to entity correlation 512, set of actions 514, and set of entities (mixed state) 516.

In some embodiments, the alert state (such as alert state 502, 504, and 506) refers to an event state. These event states are the state of a computing system (or systems) when a pre-defined set of events are occurring on the system.

Flow diagram 600 of FIG. 6 shows a series of specific action flows that can be filtered and clustered.

Flow diagram 600 includes: action flows (AF) 602, frequent action sequence 604, causal dependence graph 606, action flow clusters 608, action sequence 610, and action sequence 612.

Starting with an action flow (AF) (such as action flow 602) and/or a dictionary of action flows, embodiments of the present invention generate an action causal dependence graph (such as graph 606). Using association rule mining, embodiments of the present invention start with a series of action flows (such as action flow 602) and extract a series of common action flows with their frequency (such as frequent action sequence 604). In some embodiments, action flows are clustered based on an overlap of actions (as shown by action flow clusters 608). This process ultimately results with each group of action flows being represented by a causal dependence graph (such as graph 606).

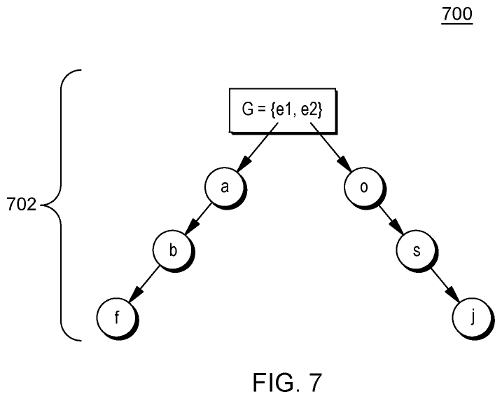

Event grouping diagram 700 of FIG. 7 is a graphical representation of a fine granular event grouping diagram. Some embodiments of the present invention project the action flows for each event in a group over the causal dependence graph in order to determine if there are any disjointed graphs (such as disjointed graph 702 shown FIG. 7). This is ultimately used as feedback to the event grouping service. In some embodiments, if the projection returns disjointed subgraphs, then it is possible to conclude that the events are not correlated to each other. This is helpful feedback to the event grouping service that indicates that there may be two different faults that must be remediated by a support engineer. In some embodiments, the event grouping service (EGS) uses this feedback for finer groupings, especially when there are simultaneous multiple faults that are found.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

User/subscriber: includes, but is not necessarily limited to, the following: (i) a single individual human; (ii) an artificial intelligence entity with sufficient intelligence to act as a user or subscriber; and/or (iii) a group of related users or subscribers.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output/report: unless otherwise explicitly specified, these words should not be taken to imply: (i) any particular degree of directness with respect to the relationship between their objects and subjects; and/or (ii) absence of intermediate components, actions and/or things interposed between their objects and subjects.

Without substantial human intervention: a process that occurs automatically (often by operation of machine logic, such as software) with little or no human input; some examples that involve “no substantial human intervention” include: (i) computer is performing complex processing and a human switches the computer to an alternative power supply due to an outage of grid power so that processing continues uninterrupted; (ii) computer is about to perform resource intensive processing, and human confirms that the resource-intensive processing should indeed be undertaken (in this case, the process of confirmation, considered in isolation, is with substantial human intervention, but the resource intensive processing does not include any substantial human intervention, notwithstanding the simple yes-no style confirmation required to be made by a human); and (iii) using machine logic, a computer has made a weighty decision (for example, a decision to ground all airplanes in anticipation of bad weather), but, before implementing the weighty decision the computer must obtain simple yes-no style confirmation from a human source.

Automatically: without any human intervention.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method (CIM) comprising:
receiving a first system state, with the first system state including a plurality of events, and with the plurality of events being included in a first grouping;
determining that the first grouping is non-satisfactory for the first system state;
responsive to the determination, taking a corrective action, by a system engineer, with the corrective action including performing a set of action(s) to a first sub-set of events included in the first grouping;
correlating the set of action(s) to the first sub-set of events to create a causal dependence graph of events; and
utilizing the causal dependence graph of events to determine a corrective action of the set of action(s) to determine the most frequently utilized corrective action.

2. The CIM of claim 1 further comprising:
receiving a set of action flows for each event of the plurality of events being included in the first grouping;
projecting the action flows for each event of the plurality of events over the causal dependence graph of events; and
determining that the projected action flows for each event of the plurality of events over the causal dependence graph of events produces a disjointed subgraph.

3. The CIM of claim 2 wherein the disjointed subgraph indicates that the events of the plurality of events are not correlated to each other.

4. The CIM of claim 1 wherein the corrective action taken by the systems engineer corresponds to correcting a computing latency that is present in the first system state.

5. The CIM of claim 1 wherein the corrective action taken by the systems engineer corresponds to correcting a high memory utilization in the first system state.

6. The CIM of claim 1 further comprising:
determining, by association rule mining, a frequency of a sequence of actions that occur in the set of action flows.

7. A computer program product (CPP) comprising:
a machine readable storage device; and
computer code stored on the machine readable storage device, with the computer code including instructions and data for causing a processor(s) set to perform operations including the following:
receiving a first system state, with the first system state including a plurality of events, and with the plurality of events being included in a first grouping,
determining that the first grouping is non-satisfactory for the first system state,
responsive to the determination, taking a corrective action, by a system engineer, with the corrective action including performing a set of action(s) to a first sub-set of events included in the first grouping,
correlating the set of action(s) to the first sub-set of events to create a causal dependence graph of events, and
utilizing the causal dependence graph of events to determine a corrective action of the set of action(s) to determine the most frequently utilized corrective action.

8. The CPP of claim 7 further comprising:
receiving a set of action flows for each event of the plurality of events being included in the first grouping;
projecting the action flows for each event of the plurality of events over the causal dependence graph of events; and
determining that the projected action flows for each event of the plurality of events over the causal dependence graph of events produces a disjointed subgraph.

9. The CPP of claim 8 wherein the disjointed subgraph indicates that the events of the plurality of events are not correlated to each other.

10. The CPP of claim 7 wherein the corrective action taken by the systems engineer corresponds to correcting a computing latency that is present in the first system state.

11. The CPP of claim 7 wherein the corrective action taken by the systems engineer corresponds to correcting a high memory utilization in the first system state.

12. The CPP of claim 7 further comprising:
determining, by association rule mining, a frequency of a sequence of actions that occur in the set of action flows.

13. A computer system (CS) comprising:
a processor(s) set;
a machine readable storage device; and
computer code stored on the machine readable storage device, with the computer code including instructions and data for causing the processor(s) set to perform operations including the following:
receiving a first system state, with the first system state including a plurality of events, and with the plurality of events being included in a first grouping,
determining that the first grouping is non-satisfactory for the first system state,
responsive to the determination, taking a corrective action, by a system engineer, with the corrective action including performing a set of action(s) to a first sub-set of events included in the first grouping,
correlating the set of action(s) to the first sub-set of events to create a causal dependence graph of events, and
utilizing the causal dependence graph of events to determine a corrective action of the set of action(s) to determine the most frequently utilized corrective action.

14. The CS of claim 13 further comprising:
receiving a set of action flows for each event of the plurality of events being included in the first grouping;
projecting the action flows for each event of the plurality of events over the causal dependence graph of events; and
determining that the projected action flows for each event of the plurality of events over the causal dependence graph of events produces a disjointed subgraph.

15. The CS of claim 14 wherein the disjointed subgraph indicates that the events of the plurality of events are not correlated to each other.

16. The CS of claim 13 wherein the corrective action taken by the systems engineer corresponds to correcting a computing latency that is present in the first system state.

17. The CS of claim 13 wherein the corrective action taken by the systems engineer corresponds to correcting a high memory utilization in the first system state.

18. The CS of claim 13 further comprising:
determining, by association rule mining, a frequency of a sequence of actions that occur in the set of action flows.
